(19) United States
(12) Patent Application Publication
(10) Pub. No.: US 2024/0029299 A1
(43) Pub. Date: Jan. 25, 2024

(54) METHOD AND DEVICE FOR MAPPING A DEPLOYMENT ENVIRONMENT FOR AT LEAST ONE MOBILE UNIT AND FOR LOCATING AT LEAST ONE MOBILE UNIT IN A DEPLOYMENT ENVIRONMENT, AND LOCATING SYSTEM FOR A DEPLOYMENT ENVIRONMENT

(71) Applicant: Robert Bosch GmbH, Stuttgart (DE)

(72) Inventors: Jan Fabian SCHMID, Hildesheim (DE); Stephan Simon, Sibbesse (DE)

(21) Appl. No.: 18/044,494

(22) PCT Filed: Oct. 15, 2021
(86) PCT No.: PCT/EP2021/078613

§ 371 Date: Mar. 8, 2023

(30) Foreign Application Priority Data
Oct. 19, 2020 (DE) 10 2020 213 151.1

(51) Int. Cl. G06T 7/73; G01C 21/00

(52) U.S. Cl. CPC G06T 7/74; G01C 21/3837; G06T 2207/20212; G06T 2207/30252; G06T 2207/30244

(57) ABSTRACT

A method for providing mapping data for a map of a deployment environment for at least one mobile unit. The method includes reading in reference image data from an interface to an image acquisition apparatus of the mobile unit. The reference image data represent reference images, which are captured by way of the image acquisition apparatus from subportions specific to each reference image of the ground of the deployment environment, wherein adjacent subportions partially overlap. Reference image features are extracted for each reference image using the reference image data. Positions of the reference image features in each reference image are determined. Using the reference image data, a reference feature descriptor is ascertained at the position of each reference image feature in order to produce mapping data. The mapping data include the reference image data, the positions of the reference image features and the reference feature descriptors.

### FIELD

The present invention relates to a device and a method for providing mapping data for a map of a deployment environment for at least one mobile unit. The present invention also provides a computer program.

### BACKGROUND INFORMATION

Various methods are described in the related art for feature-based localization on the basis of ground textures or for absolute or map-based localization on the basis of ground texture features. Random feature image regions can, for example, be used for feature extraction, but hitherto in particular only in applications where it is not a matter of finding correspondences between pairs of images and thus in particular also not of localization tasks, but rather where the aim is to understand image content. Examples of such applications are image classification or object recognition. Such applications in particular relate to methods which proceed entirely on one system, such as for example an autonomous vehicle or robot.

German Patent Application No. DE 10 2017 220 291 A1 describes a method for automatically guiding a vehicle along a virtual rail system. This is a method with which an autonomous system with a downward-facing camera can follow a previously taught virtual rail.

### SUMMARY

The present invention provides methods, devices using these methods, and a corresponding computer program. The measures disclosed herein enable advantageous embodiments, developments, and improvements to the general method disclosed herein.

According to example embodiments of the present invention, efficient feature detection for ground texture-based mapping and/or localization in a deployment environment for at least one mobile unit can in particular be enabled. More precisely, a simplified approach to feature detection for ground texture-based mapping and/or localization can for example be used for this purpose. In other words, an efficient process for feature detection can be provided for localization with the assistance of images from a downward-facing camera. Feature detection can here in particular be carried out independently of the actual image content, by defining feature positions either by a random process or by a fixed pattern. Deployment may proceed substantially independently of subsequent localization steps such as feature description, correspondence finding, and pose determination. Embodiments may be based, in particular, on its being possible to replace actual feature detection with the use of arbitrary image regions for the mapping process and/or localization process. This means that computing time can be saved by determining the image regions used for feature extraction randomly or pseudorandomly or based on a static pattern. The following reasons in particular explain why this type of feature detection is a valid approach to feature-based localization on the basis of ground textures.

Firstly, the probability of randomly selecting similar image regions may be considered to be relatively high. This is because a camera pose can be described in a good approximation with only three parameters: the x and y coordinates in the ground plane and an orientation angle. In particular, the distance to the ground is known such that an image region size used can be kept constant. For example, if a current pose estimate is already available during localization, complexity can be further reduced. In particular, if orientation is estimated with sufficient precision, the parameters of the feature image regions to be determined can be reduced to their image coordinates. If a feature descriptor with a certain degree of translational robustness is used, such that even slightly shifted image regions can be evaluated to similar descriptors, there is a high probability that correct correspondences between overlapping image pairs will be found despite the feature image regions used having been selected randomly. Secondly, it can be assumed that ground textures have a high information content. Given a suitable feature descriptor, there is in particular no need to use particular feature image regions, i.e. in particular those with a particularly high information content, for correspondence finding. Rather, typical ground textures such as concrete, asphalt, or carpet, for example, may have sufficient characteristic properties everywhere to permit correspondence finding, providing that sufficiently overlapping feature image regions are used in the localization and reference image.

According to example embodiments of the present invention, it is in particular possible to reduce the computational overhead involved in high-precision mapping and/or localization on the basis of ground texture features. It is thus possible to avoid the use of conventional, frequently computationally intensive methods for feature detection, such as for example SIFT (Lowe, 2004), which determine suitable image regions for correspondence finding. In such conventional methods, it is in particular possible to determine image regions in which a specific property is most strongly manifested, this also being known as global optimization. One example of such a property is contrast relative to the local surroundings. Compared with such methods, embodiments can reduce a computational overhead due to the elimination of optimization, wherein the use of randomly or uniformly distributed feature image regions presented here involves a reduced computational overhead without any consequent impairment of localization capability.

Advantages which can be achieved compared to the related art include the following. Firstly, the above mentioned reduced computational overhead for feature extraction can be mentioned. While a larger number of features can be used due to the lower probability of finding corresponding features, the overall computational overhead for localization can be significantly reduced when using efficient processes for feature description, correspondence finding as well as for screening out incorrect correspondences or selecting correct correspondences. Suitable efficient feature description methods may be, for example, binary descriptors such as BRIEF (Calonder et al., 2010), BRISK (Leutenegger et al., 2011), LATCH (Levi and Hassner, 2016) or AKAZE (Alcantarilla et al., 2013). In addition to the lower computational overhead, the use of random feature image regions can be an advantage on specific ground texture types. This is due to a phenomenon which can occur with ground textures with highly repetitive patterns. Using classical feature detectors for such textures can, for example, result in the same locations in the pattern always being determined as feature image regions. In such a case, it may under certain circumstances no longer be possible, or only with difficulty, for the localization method to distinguish between different manifestations of the pattern. This can be prevented by using random or pseudorandom feature image regions.

According to an example embodiment of the present invention, a method is provided for providing mapping data for a map of a deployment environment for at least one mobile unit, wherein the method has the following steps:
reading in reference image data from an interface to an image acquisition apparatus of the mobile unit, wherein the reference image data represent a plurality of reference images which are captured by way of the image acquisition apparatus from subportions specific to each reference image of the ground of the deployment environment, wherein adjacent subportions partially overlap;
extracting a plurality of reference image features for each reference image using the reference image data, wherein positions of the reference image features in each reference image are determined by way of a random process and additionally or alternatively according to a predefined distribution scheme;
producing the mapping data, wherein, using the reference image data, a reference feature descriptor is ascertained at the position of each reference image feature, wherein the mapping data include the reference image data, the positions of the reference image features and the reference feature descriptors.

The deployment environment may be an area accessible to the least one mobile unit within and additionally or alternatively outside one or more buildings. The deployment environment may have predefined boundaries. The at least one mobile unit can take the form of a vehicle for highly automated driving, a robot, or the like. The image acquisition apparatus may include at least one camera of a mobile unit. The image acquisition apparatus may be arranged in a defined orientation relative to the mobile unit. The image acquisition apparatus may be a camera.

According to an example embodiment of the present invention, a method is also provided for creating a map of a deployment environment for at least one mobile unit, wherein the method has the following steps:
receiving mapping data from a communication interface to the at least one mobile unit, wherein the mapping data are provided according to an embodiment of the above-described provision method;
determining a reference pose of the image acquisition apparatus for each reference image relative to a reference coordinate system using the mapping data and as a function of correspondences between reference image features of overlapping reference images ascertained using the reference feature descriptors; and
combining the reference images as a function of the reference poses, the positions of the reference image features, the reference feature descriptors and the reference poses in order to create the map of the deployment environment.

The method for creating the map may be carried out for example on or using a data processing apparatus. The data processing apparatus can here be arranged separately from the at least one mobile unit within or outside the deployment environment.

According to one example embodiment of the present invention, in the determination step, the reference pose can be determined as a function of correspondences between reference image features for which reference feature descriptors satisfying a similarity criterion with regard to one another have been ascertained in overlapping reference images. Such an embodiment offers the advantage that using such a reproducibility condition can improve robustness to image transformations, such as for example translation and rotation of the image acquisition apparatus, and photometric transformations, which can in turn also be beneficial in localization, since more correct correspondences can be found.

According to an example embodiment of the present invention, a method for determining localization data for localizing at least one mobile unit in a deployment environment is furthermore provided, wherein the method has the following steps:
reading in image data from an interface to an image acquisition apparatus of the mobile unit, wherein the image data represent at least one image, which is captured by way of the image acquisition apparatus, of a subportion of the ground of the deployment environment;
extracting a plurality of image features for the image using the image data, wherein positions of the image features in the image are determined by way of a random process and additionally or alternatively according to a predefined distribution scheme;
generating a feature descriptor at the position of each image feature using the image data in order to determine the localization data, wherein the localization data include the positions of the image features and the feature descriptors.

The at least one mobile unit may be the at least one mobile unit from one of the above-stated methods or at least one further mobile unit which is the same as or similar to the at least one mobile unit from one of the above-stated methods. At least some of the steps of the method can be repeated or cyclically repeated for each image. The images and thus adjacent subportions represented by the images may overlap.

Optionally, the reference feature descriptor and/or the feature descriptor can be a binary descriptor. Using binary descriptors can be advantageous because they are typically faster to compute than non-binary or floating-point descriptors, and because binary descriptors enable particularly efficient correspondence formation.

According to one example embodiment of the present invention, the determination method may include a step of outputting the localization data at an interface to a data processing apparatus. The localization data can here be output in a plurality of data packets. Each data packet may include at least one position of an image feature and at least one feature descriptor. A data packet can be output as soon as at least one feature descriptor is generated. Such an embodiment offers the advantage that it is possible to efficiently implement a centralized ground texture feature-based localization method, in which image processing and relative pose determination or visual odometry take place on the mobile units or robots while absolute pose determination on the basis of a previously captured map is outsourced to a central server. In particular, the three steps of the localization method, i.e. image processing, communication and localization, can here be carried out in parallel or in partially overlapping manner. Using random or predefined feature ranges allows features to be computed one after another and then sent directly to the data processing apparatus or the server. The server thus receives a constant stream of extracted image features from the mobile unit, such that image processing and communication can take place in parallel or in partially overlapping manner. The subsequent localization, which takes place on the server, on the basis of the received image features from the localization image, as well as the map of the application area, can likewise be carried out in parallel or in partially overlapping manner. The image can also be systematically and/or completely searched on the basis of a feature criterion and, whenever an image region which meets this criterion is found, the descriptor can be computed and the feature information can then be sent to the server. With regard to the feature detector, there is no need to search for globally optimal image regions for feature formation.

According to an example embodiment of the present invention, the determination method may also comprise a step of eliciting correspondences between image features of the localization data and reference image features of a preceding image using the feature descriptors of the localization data and reference feature descriptors of the preceding image. The determination method may furthermore comprise a step of determining a pose of the image acquisition apparatus for the image relative to the reference coordinate system as a function of the correspondences elicited in the eliciting step, in order to carry out localization. Such an embodiment offers the advantage that incremental or relative localization can be carried out, wherein a relative camera pose with respect to a preceding camera pose can be determined, even should, for example, a data link to the data processing apparatus be interrupted.

According to one example embodiment of the above-stated provision method and/or of the above-stated determination method, a random process and additionally or alternatively a predefined distribution scheme can be used in the extraction step, in which a list with all the possible image positions of reference image features or image features is produced and the list is pseudorandomly shuffled or positions are pseudorandomly selected from the list, and additionally or alternatively in which a fixed pattern of positions or one of a number of pseudorandomly created patterns of positions is used. The advantage of a ground texture-based localization method which uses feature image regions which are arbitrary or independent of an actual image content, whether random or predefined, for correspondence formation is that the computational overhead for image processing can be reduced since, in contrast with using a conventional feature detector, there is no need to fully process the entire image in order to identify the optimal feature image regions. Instead, features at arbitrary locations in the reference image or image can be computed. Such a method additionally has the advantage that image processing can still be under way when the information is used in the next processing step.

According to a further example embodiment of the above-stated provision method and/or of the above-stated determination method, it is possible in the extraction step to use a random process and additionally or alternatively a predefined distribution scheme, in which a variable or defined number of positions are used and additionally or alternatively in which different distribution densities of positions are defined for different subregions of a reference image or of the image. Such an embodiment offers the advantage that an improved adaptation to the actual circumstances in the deployment environment, more precisely of the ground, can be made.

According to an example embodiment of the present invention, a method for localizing at least one mobile unit in a deployment environment is also provided, wherein the method has the following steps:
receiving localization data from a communication interface to the at least one mobile unit, wherein the localization data are determined according to one embodiment of the above-stated determination method;
ascertaining correspondences between image features of the localization data and reference image features of a map created according to one embodiment of the above-stated creation method using the feature descriptors of the localization data and the reference feature descriptors of the map;
determining a pose of the image acquisition apparatus for the image relative to the reference coordinate system as a function of correspondences ascertained in the ascertaining step and using the reference poses of the map in order to generate pose information which represents the pose; and
outputting the pose information at the communication interface to the at least one mobile unit in order to carry out localization.

The localization method can for example be carried out on or using a data processing apparatus. The data processing apparatus can here be arranged separately from the at least one mobile unit within or outside the deployment environment.

According to one example embodiment of the present invention, weighting values and additionally or alternatively confidence values may be applied in the determination step to the correspondences ascertained in the ascertaining step in order to generate scored correspondences. The pose can here be determined as a function of the scored correspondences. Such an embodiment offers the advantage that the reliability, robustness and accuracy of localization can be further increased, in particular since incorrect or less correct correspondences can be screened out.

Each of the above-stated methods can be implemented, for example, in software or hardware or in a combination of software and hardware for example in a controller or a device.

The approach according to the present invention presented here further provides a device for a mobile unit, wherein the device is configured to carry out, control or implement the steps of a variant of the provision method presented here and/or of the determination method presented here in appropriate apparatuses. This variant embodiment of the invention in the form of a device for a mobile unit is also capable of quickly and efficiently achieving the object underlying the invention. The approach presented here furthermore provides a device for a data processing apparatus, wherein the device is configured to carry out, control or implement the steps of a variant of the method for creating a map presented here and/or of the localization method presented here in appropriate apparatuses. This variant embodiment of the invention in the form of a device for a data processing apparatus is also capable of quickly and efficiently achieving the object underlying the invention.

The device may to this end have at least one computing unit for processing signals or data, at least one memory unit for storing signals or data, at least one interface to a sensor or an actuator for reading in sensor signals from the sensor or for outputting data or control signals to the actuator and/or at least one communication interface for reading in or outputting data embedded in a communication protocol. The computing unit may be, for example, a signal processor, a microcontroller, or the like, wherein the memory unit may be a flash memory, an EEPROM or a magnetic memory unit. The communication interface may be configured to read in or output data wirelessly and/or by wired connection, wherein a communication interface which can read in or output wire-carried data can read in these data for example electrically or optically from an appropriate data transmission line or output them into an appropriate data transmission line.

A device may in the present context be taken to mean an electrical appliance which processes the sensor signals and, as a function thereof, outputs control and/or data signals. The device may have an interface which may take the form of hardware and/or software. When in hardware form, the interfaces may for example be part of a “system ASIC” which contains many and varied functions of the device. It is, however, also possible for the interfaces to be separate, integrated circuits or to consist at least in part of discrete components. When in software form, the interfaces may be software modules which, in addition to other software modules, are present, for example, on a microcontroller.

According to an example embodiment of the present invention, a localization system for a deployment environment in which at least one mobile unit is deployable is also provided, wherein the localization system has the following features:

the at least one mobile unit, wherein the mobile unit includes an embodiment of the above-stated device for a mobile unit; and
a data processing apparatus, wherein the data processing apparatus includes an embodiment of the above-stated device for a data processing apparatus, wherein the device for the mobile unit and the device for the data processing apparatus are connected to one another in data transmission enabled manner.

In particular, the localization system can include the data processing apparatus and a plurality of mobile units. At least one of the mobile units can optionally include a device for a mobile unit which is configured to carry out, control or implement the steps of a variant of the provision method presented here in appropriate apparatuses.

A computer program product or computer program with program code which can be stored on a machine-readable carrier or storage medium such as a semiconductor memory, hard disk memory or an optical storage device and is used to carry out, implement and/or control the steps of the method according to one of the above-described embodiments of the present invention, in particular when the program product or program is executed on a computer or a device is also advantageous.

Exemplary embodiments of the present invention are shown in the figures and explained in greater detail in the following description.

### BRIEF DESCRIPTION OF THE DRAWINGS

FIG. 1 shows a schematic representation of an exemplary embodiment of a localization system for a deployment environment, according to the present invention.

FIG. 2 shows a schematic representation of an exemplary embodiment of a device for a mobile unit, according to the present invention.

FIG. 3 shows a schematic representation of an exemplary embodiment of a device for a mobile unit, according to the present invention.

FIG. 4 shows a schematic representation of an exemplary embodiment of a device for a data processing apparatus, according to the present invention.

FIG. 5 shows a schematic representation of an exemplary embodiment of a device for a data processing apparatus, according to the present invention.

FIG. 6 shows a flowchart of an exemplary embodiment of a method for providing mapping data for a map of a deployment environment for at least one mobile unit, according to the present invention.

FIG. 7 shows a flowchart of an exemplary embodiment of a method for creating a map of a deployment environment for at least one mobile unit, according to the present invention.

FIG. 8 shows a flowchart of an exemplary embodiment of a method for determining localization data for localizing at least one mobile unit in a deployment environment, according to the present invention.

FIG. 9 shows a flowchart of an exemplary embodiment of a method for localizing at least one mobile unit in a deployment environment, according to the present invention.

FIG. 10 shows a schematic representation of an image and of feature image regions.

FIG. 11 shows a schematic representation of an image 1123 and of image features 335 according to an exemplary embodiment of the present invention.

FIG. 12 shows a schematic representation of overlapping images with feature image regions.

FIG. 13 shows a schematic representation of overlapping images 1123 and of image features 335 according to an exemplary embodiment of the present invention.

FIG. 14 shows a schematic representation of a reproducibility condition according to an example embodiment of the present invention.

FIG. 15 shows a schematic representation of a time sequence of three phases of a centralized image feature-based localization.

### DETAILED DESCRIPTION OF EXAMPLE EMBODIMENTS

In the following description of favorable exemplary embodiments of the present invention, the same or similar reference signs are used for the elements shown in the various figures and having a similar action, a repeated description of these elements not being provided.

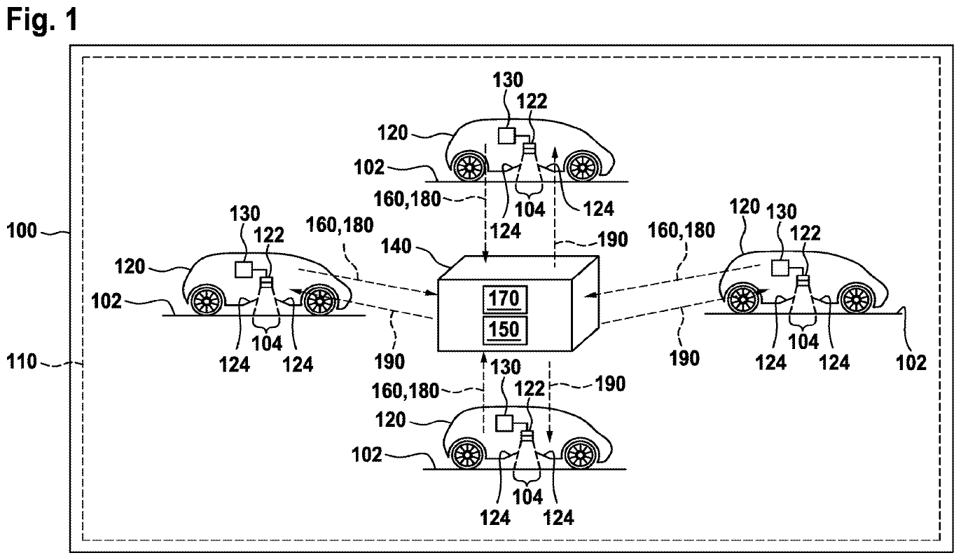

FIG. 1 shows a schematic representation of an exemplary embodiment of a localization system 110 for a deployment environment 100. At least one mobile unit 120 is deployable in the deployment environment 100. In the representation of FIG. 1, just four mobile units 120 are shown by way of example in the deployment environment 100. The deployment environment 100 is, for example, an area accessible to the at least one mobile unit 120 within and/or outside at least one building. The deployment environment 100 includes ground 102 on which the at least one mobile unit 120 can move. The at least one mobile unit 120 is a vehicle for highly automated driving, in particular a robot or robotic vehicle or the like.

The localization system 110 comprises the at least one mobile unit 120 and a data processing apparatus 140. The data processing apparatus 140 is arranged within and/or outside the deployment environment 100. In the representation of FIG. 1, the data processing apparatus 140 is shown merely by way of example within the deployment environment 100. The data processing apparatus 140 is configured to carry out data processing for the at least one mobile unit 120.

Each mobile unit 120 comprises an image acquisition apparatus 122, the field of view of which is directed onto the ground 102 of the deployment environment 100. The image acquisition apparatus 122 is a camera. Each mobile unit 120 optionally comprises at least one lighting apparatus 124 for illuminating the field of view of the image acquisition apparatus 122. According to the exemplary embodiment shown in FIG. 1 each mobile unit 120 comprises by way of example an annularly shaped lighting apparatus 124. A subportion 104 of the ground 102 of the deployment environment 100 can be imaged per image capture operation of the image acquisition apparatus 122. Each mobile unit 120 furthermore comprises a device 130 for a mobile unit.

The device 130 for a mobile unit is connected in data or signal transmission enabled manner with the image acquisition apparatus 122 or can alternatively be part thereof. The device 130 for a mobile unit is configured to carry out a method for providing mapping data 160 for a map 170 of the deployment environment 100 and/or a method for determining localization data 180 for localizing the at least one mobile unit 120 in the deployment environment 100. Further details regarding the device 130 for a mobile unit are provided below with reference to the following figures.

The data processing apparatus 140 comprises a device 150 for a data processing apparatus. The device 150 for a data processing apparatus is configured to carry out a method for creating the map 170 of the deployment environment 100 and/or a method for localizing the at least one mobile unit 120 in the deployment environment 100. The device 130 for the mobile unit and the device 150 for a data processing apparatus are here connected to one another in data transmission enabled manner, in particular by way of a radio link, for example WLAN or mobile radio. The mapping data 160 and/or the localization data 180 or image features are here transmittable from the at least one mobile unit 120 to the data processing apparatus 140 and pose information 190 or an estimated robot pose for localization is transmittable from the data processing apparatus 140 to each mobile unit 120.

In other words, in the deployment environment 100, there are a plurality of autonomous robots or mobile units 120 in radio contact with a data processing apparatus 140 which is also denoted central server with stored map 170. Each mobile unit 120 is equipped with a downward-facing camera or image acquisition apparatus 122. In addition, the field of view or capture region can be artificially illuminated such that localization can be carried out reliably independently of external light conditions. The mobile units 120 take images of the ground 102 at regular intervals in order to determine their own pose. To this end, features are extracted from the image at arbitrary locations and are sent in succession to the server or data processing apparatus 140 where in particular a ground texture map is created and/or stored, with which the poses of the mobile units 120 can be estimated on the basis of the sent features or localization data 180. According to one exemplary embodiment, feature extraction, communication and pose estimation can be carried out at least partially in parallel for this purpose, resulting in a runtime advantage over a method in which each of these three steps has to be fully completed before the next one can start. Once localization is complete, the estimated pose in the form of pose information 190 is sent back to the mobile unit 120 which can, for example, use the pose information 155 to precisely position itself. WLAN or 5G may, for example, be used for the radio link between the server and the robots.

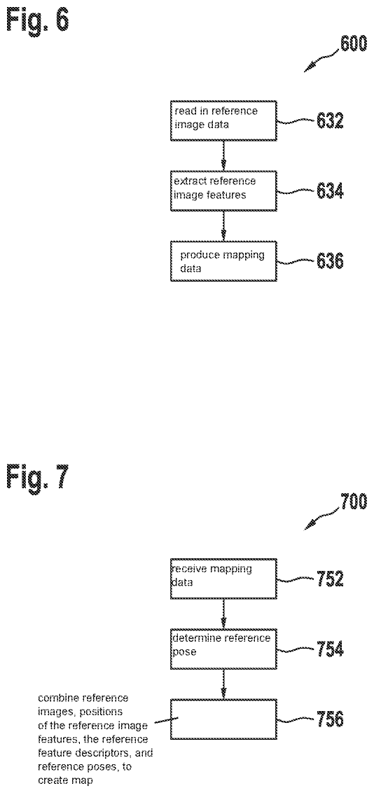

FIG. 2 shows a schematic representation of an exemplary embodiment of a device 130 for a mobile unit. The device 130 for a mobile unit is the same as or similar to the device for a mobile unit from FIG. 1. The device 130 for a mobile unit shown in FIG. 2 is configured to carry out and/or control steps of a method for providing mapping data 160 for the map of the deployment environment for the at least one mobile unit in appropriate apparatuses. For example, the provision method is the same as or similar to the method from FIG. 6.

The device 130 for a mobile unit comprises a read-in apparatus 232, an extraction apparatus 234 and a production apparatus 236. The read-in apparatus 232 is configured to read reference image data 223 from an interface 231 into an image acquisition apparatus of the mobile unit. The reference image data 223 represent a plurality of reference images which are captured by way of the image acquisition apparatus from subportions specific to each reference image of the ground of the deployment environment. Adjacent subportions here partially overlap one another. The read-in apparatus 232 is furthermore configured to forward the reference image data 223 to the extraction apparatus 234. The extraction apparatus 234 is configured to extract, using the reference image data 223, a plurality of reference image features 235 for each reference image. Positions of the reference image features 235 in each reference image are determined by way of a random process and/or according to a predefined distribution scheme. The extraction apparatus 234 is also configured to forward the reference image features 235 to the production apparatus 236. The production apparatus 236 is configured to produce the mapping data 160, wherein, using the reference image data, a reference feature descriptor is ascertained at the position of each reference image feature 235. The mapping data 160 include the reference image data 223, the positions of the reference image features 235 and the reference feature descriptors. The device 130 for a mobile unit is furthermore configured to output the mapping data 160 at a further interface 239 to the data processing apparatus.

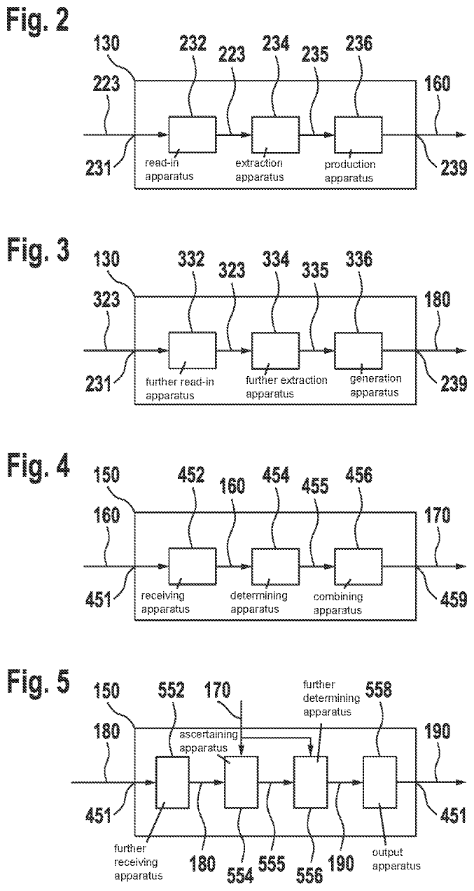

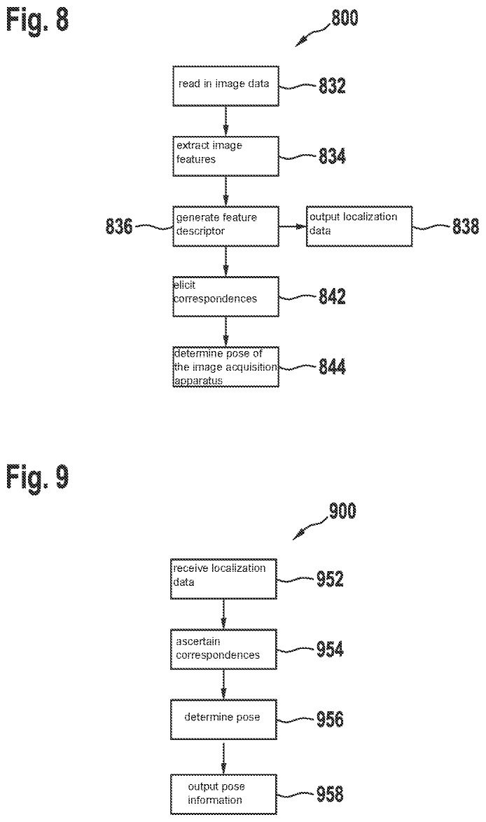

FIG. 3 shows a schematic representation of an exemplary embodiment of a device 130 for a mobile unit. The device 130 for a mobile unit is the same as or similar to the device for a mobile unit from FIG. 1 or FIG. 2. The device 130 for a mobile unit shown in FIG. 3 is configured to carry out and/or control steps of a method for determining localization data 180 for the localization of the at least one mobile unit in the deployment environment in appropriate apparatuses. The determination method is the same as or similar to the method from FIG. 8.

The device 130 for a mobile unit comprises a further read-in apparatus 332, a further extraction apparatus 334 and a generation apparatus 336. The read-in apparatus 332 is configured to read in image data 323 from the interface 231 to the image acquisition apparatus of the mobile unit. The image data 323 represent at least one image which is captured by way of the image acquisition apparatus of a subportion of the ground of the deployment environment. The further read-in apparatus 332 is also configured to forward the image data 323 to the further extraction apparatus 334. The further extraction apparatus 334 is configured to extract, using the image data 323, a plurality of image features 335 for the image. Positions of the image features 335 in the image are here determined by way of a random process and/or according to a predefined distribution scheme. The further extraction apparatus 334 is configured to forward the image features 335 to the generation apparatus 336. The generation apparatus 336 is configured to generate a feature descriptor using the image data 323 at the position of each image feature 335 in order to determine the localization data 180. The localization data 180 comprise the positions of the image features 335 and the feature descriptors.

The device 130 for a mobile unit is in particular configured to output the localization data 180 at the further interface 239 to the data processing apparatus. According to one exemplary embodiment, the localization data 180 are output in a plurality of data packets, wherein each data packet comprises at least one position of an image feature 335 and at least one feature descriptor. More precisely, according to this exemplary embodiment, the position of each image feature 335 and the associated feature descriptor is output in a data packet as soon as the feature descriptor is generated. Data packets can thus be output at least partially in parallel and further image features 335 can be extracted and feature descriptors generated.

FIG. 4 shows a schematic representation of an exemplary embodiment of a device 150 for a data processing apparatus. The device 150 for a data processing apparatus is the same as or similar to the device for a data processing apparatus from FIG. 1. The device 150 for a data processing apparatus shown in FIG. 4 is configured to carry out and/or control steps of a method for creating the map 170 of the deployment environment for the at least one mobile unit in appropriate apparatuses. The creation method is the same as or similar to the method from FIG. 7.

The device 150 for a data processing apparatus comprises a receiving apparatus 452, a determining apparatus 454 and a combining apparatus 456. The receiving apparatus 452 is configured to receive the mapping data 160 from a communication interface 451 to the at least one mobile unit. The mapping data 160 are here provided by way of the device for a mobile unit. The receiving apparatus 452 is furthermore configured to forward the mapping data 160 to the determining apparatus 454. Using the mapping data 160 and as a function of correspondences between reference image features of overlapping reference images ascertained using the reference feature descriptors, the determining apparatus 454 is configured to determine a reference pose 455 of the image acquisition apparatus for each reference image relative to a reference coordinate system. The determining apparatus 454 is also configured to forward the reference poses 455 to the combining apparatus 456. As a function of the reference poses 455, the combining apparatus 456 is configured to combine the reference images, the positions of the reference image features, the reference feature descriptors and the reference poses 455 in order to generate the map 170 of the deployment environment. The device 150 for a data processing apparatus is in particular also configured to output the map 170 at a memory interface 459 to a memory apparatus of the data processing apparatus.

FIG. 5 shows a schematic representation of an exemplary embodiment of a device 150 for a data processing apparatus. The device 150 for a data processing apparatus is the same as or similar to the device for a data processing apparatus from FIG. 1 or FIG. 4. The device 150 for a data processing apparatus shown in FIG. 5 is configured to carry out and/or control steps of a method for localizing the at least one mobile unit in the deployment environment in appropriate apparatuses. The localization method is the same as or similar to the method from FIG. 9, for example.

The device 150 for a data processing apparatus comprises a further receiving apparatus 552, an ascertaining apparatus 554, a further determining apparatus 556 and a output apparatus 558. The further receiving apparatus 552 is configured to receive the localization data 180 from the communication interface 451 to the at least one mobile unit. The localization data 180 are here determined by way of the device for a mobile unit. The further receiving apparatus 552 is also configured to forward the localization data 180 to the ascertaining apparatus 554. Using the feature descriptors of the localization data 180 and the reference feature descriptors of the map 170, the ascertaining apparatus 554 is configured to ascertain correspondences 555 between image features of the localization data 180 and reference image features of the map 170. The ascertaining apparatus 554 is furthermore configured to forward the correspondences 555 to the further determining apparatus 556. As a function of the correspondences 555 and using the reference poses of the map 170, the further determining apparatus 556 is configured to determine a pose of the image acquisition apparatus for the image relative to the reference coordinate system in order to generate the pose information 190. The pose information 190 represents the specific pose. The further determining apparatus 556 is also configured to output the pose information 190 via the output apparatus 558 at the communication interface 451 to the at least one mobile unit in order to carry out localization.

FIG. 6 shows a flowchart of an exemplary embodiment of a method 600 for providing mapping data for a map of a deployment environment for at least one mobile unit. The provision method 600 comprises a reading-in step 632, an extraction step 634 and a production step 636. In the reading-in step 632, reference image data are read in from an interface to an image acquisition apparatus of the mobile unit. The reference image data represent a plurality of reference images which are captured by way of the image acquisition apparatus from subportions specific to each reference image of the ground of the deployment environment, wherein adjacent subportions partially overlap. In the extraction step 634, using the reference image data, a plurality of reference image features are extracted for each reference image. Positions of the reference image features in each reference image are here determined by way of a random process and/or according to a predefined distribution scheme. In the production step 636, the mapping data are produced. Using the reference image data, a reference feature descriptor is here ascertained at the position of each reference image feature. The mapping data comprise the reference image data, the positions of the reference image features and the reference feature descriptors.

FIG. 7 shows a flowchart of an exemplary embodiment of a method 700 for creating a map of a deployment environment for at least one mobile unit. The creation method 700 comprises a receiving step 752, a determining step 754 and a combining step 756. In the receiving step 752, mapping data which are provided according to the method shown in FIG. 6 or a similar method are received from a communication interface to the at least one mobile unit. In the determining step 754, using the mapping data and as a function of correspondences ascertained using the reference feature descriptors between reference image features of overlapping reference images, a reference pose of the image acquisition apparatus is determined for each reference image relative to a reference coordinate system. As a function of the reference poses, in the combining step 756, the reference images, the positions of the reference image features, the reference feature descriptors and the reference poses are combined in order to create the map of the deployment environment.

According to one exemplary embodiment of the method 700 for creating the map, in the determining step 754, the reference pose is determined as a function of correspondences between reference image features for which reference feature descriptors satisfying a similarity criterion with regard to one another have been ascertained in overlapping reference images.

FIG. 8 shows a flowchart of an exemplary embodiment of a method 800 for determining localization data for localizing at least one mobile unit in a deployment environment. The determining method 800 comprises a reading-in step 832, an extraction step 834 and a generation step 836. In the reading-in step 832, image data are read in from an interface to an image acquisition apparatus of the mobile unit. The image data represent at least one image which is captured by way of the image acquisition apparatus of a subportion of the ground of the deployment environment. In the extraction step 834, a plurality of image features for the image are extracted using the image data. Positions of the image features in the image are here determined by way of a random process and/or according to a predefined distribution scheme. In the generation step 836, using the image data, a feature descriptor is generated at the position of each image feature in order to determine the localization data. The localization data comprise the positions of the image features and the feature descriptors.

In particular, the method 800 for determining the localization data furthermore comprises a step 838 of outputting the localization data at an interface to a data processing apparatus. The localization data are here output in a plurality of data packets, wherein each data packet comprises at least one position of an image feature and at least one feature descriptor. The output step 838 is, for example, carried out repeatedly such that the position of each image feature 335 and the associated feature descriptor are output in a data packet as soon as the feature descriptor is generated. Data packets can thus be output and, at least partially in parallel thereto, further image features 335 can be extracted and feature descriptors generated.

According to one exemplary embodiment, the method 800 for determining the localization data also comprises a step 842 of eliciting correspondences between image features of the localization data and reference image features of a preceding image using the feature descriptors of the localization data and reference feature descriptors of the preceding image furthermore together with a step 844 of determining a pose of the image acquisition apparatus for the image relative to the reference coordinate system as a function of the correspondences elicited in the elicitation step 842 in order to carry out localization. This exemplary embodiment can at least temporarily permit autonomous localization of the at least one mobile unit in the event of any interruptions in data transmission within the deployment environment.

With reference to the method 600 for providing the map data shown in FIG. 6 and/or the method 800 for determining the localization data shown in FIG. 8, extraction step 634 and/or 834 makes use of a random process and/or a predefined distribution scheme, in which a list with all the possible image positions of reference image features or image features is produced and the list is pseudorandomly shuffled or positions are pseudorandomly selected from the list, and/or in which a fixed pattern of positions or one of a number of pseudorandomly created patterns of positions is used. Additionally or alternatively, use is made in extraction step 634 and/or 834 of a random process and/or a predefined distribution scheme in which a variable or defined number of positions is used and/or in which different distribution densities of positions are determined for different subregions of a reference image or of the image.

FIG. 9 shows a flowchart of an exemplary embodiment of a method 900 for localizing at least one mobile unit in a deployment environment. The localization method 900 comprises a receiving step 952, an ascertaining step 954, a determination step 956 and an output step 958. In the receiving step 952, localization data which are determined according to the method shown in FIG. 8 or a similar method are received from a communication interface to the at least one mobile unit. In the ascertaining step 954, correspondences between image features of the localization data and reference image features of the map are ascertained using the feature descriptors of the localization data and the reference feature descriptors of the map created according to the method shown in FIG. 7 or a similar method. In the determination step 956, as a function of the correspondences ascertained in the ascertaining step 954 and using the reference poses of the map, a pose of the image acquisition apparatus for the image relative to the reference coordinate system is determined in order to generate pose information which represents the pose. In the output step 958, the pose information is output at the communication interface to the at least one mobile unit output in order to carry out localization.

According to one exemplary embodiment, in the determination step 956 weighting values and/or confidence values are applied to the correspondences ascertained in the ascertaining step 954 in order to generate scored correspondences. The pose is then determined in the determination step 956 as a function of the scored correspondences.

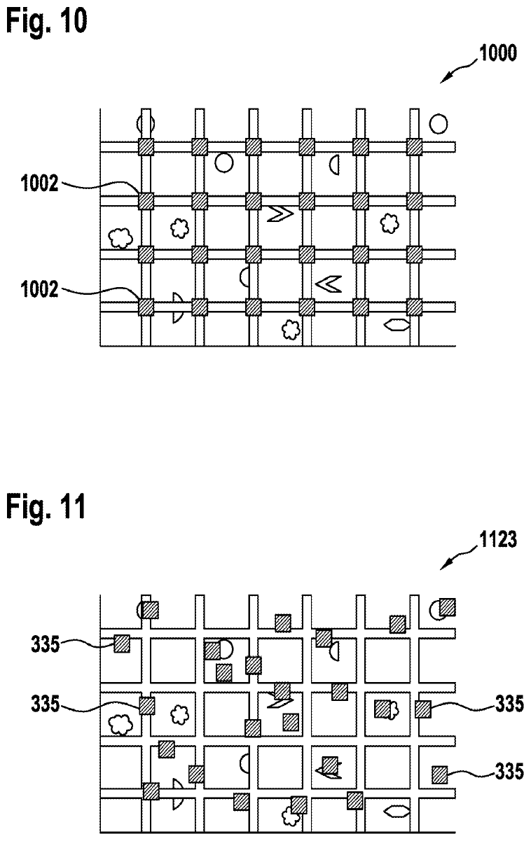

FIG. 10 shows a schematic representation of an image 1000 and of feature image regions 1002. A plurality of feature image regions 1002 are here extracted using a classical or conventional method from image data representing the image 1000. FIG. 10 represents a schematic example of a case in which using a conventional feature detector can fail. Feature detectors find feature image regions 1002 by searching the entire image 1000 for those locations which satisfy a specific criterion or where a specific property is most strongly manifested. In FIG. 10, the feature detector can, for example, search for the locations with the highest contrast. The texture shown in image 1000 has a very regular structure which is shown here as a grid. This regular structure may now be precisely such that a property to be maximized by the feature detector, in this case strong contrast, is strongly manifested at specific locations which occur correspondingly repeatedly in the regular structure. These locations, which the detector correspondingly extracts as feature image regions 1002, are shown by squares in FIG. 10 and have the highest contrast between inner and outer regions of the feature. One difficulty now is, for example, that the feature image regions 1002 have a very similar, in an extreme case identical, content such that they and their corresponding descriptors cannot be differentiated from one another. This complicates correspondence finding of the image 1000 shown here with further feature image regions of an overlapping further image because, for each feature extracted from the further image, either all the features from image 1000, the feature image regions 1002, correspond therewith or none corresponds therewith. In both cases, it can be difficult to obtain useful information for localization. This is merely a schematic example. In principle, an image 1000 can be created for each feature detector in which the found feature image regions 1002 are degenerate in a similar manner.

FIG. 11 shows a schematic representation of an image 1123 and of image features 335 according to an exemplary embodiment. The image features 335 are extracted from image data representing the image 1123 by carrying out the method for determining localization data from FIG. 8 or a similar method. The positions of the image features 335 in the image 1123 are thus determined by way of a random process and/or according to a predefined distribution scheme, in other words independently of a specific image content of the image 1123. The image content shown in FIG. 11 here corresponds to the image content of the image from FIG. 10.

When randomly distributed feature image regions or image features 335 are used, the problem described in FIG. 10 does not occur. Away from the feature image regions from FIG. 10 previously extracted by the feature detector, the image 1123 certainly does contain features usable for localization, which are here represented by irregular symbols. Some of the here randomly selected feature image regions or image features 335 also fall on parts of the regular structure shown as a grid and, like the feature image regions from FIG. 10, are of only limited use for correspondence formation. However, some of the arbitrarily positioned image features 335 also contain the uniquely identifiable, irregular image content between the struts of the lattice. At least some of these usable image features 335 can also be found in an overlapping image used for localization, wherein the image features 335 need not have precisely the same image content in pixel terms such that localization can proceed successfully.

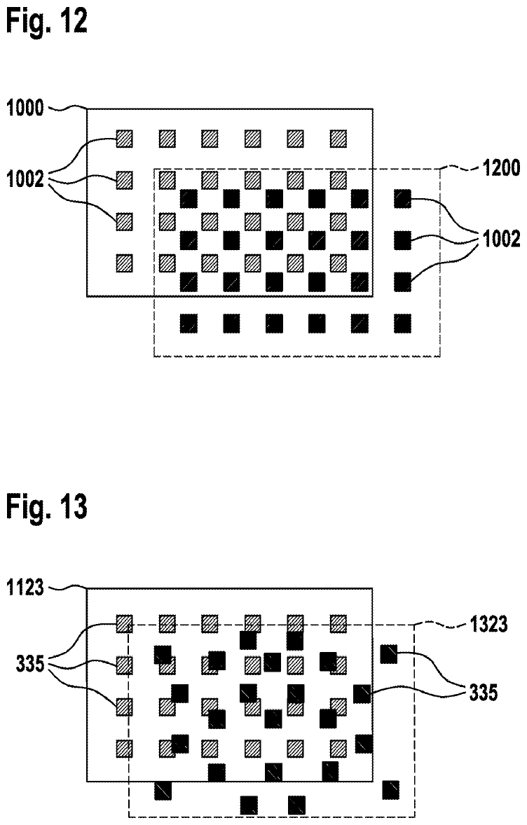

FIG. 12 shows a schematic representation of overlapping images 1000, 1200 with feature image regions 1002. The feature image regions 1002 in the two images 1000, 1200 correspond merely by way of example to the feature image regions from FIG. 10. In other words, using the same pattern of feature positions in overlapping images such as 1000, 1200 can result in the feature image regions 1002 being shifted relative to one another precisely such that there are no overlapping features and thus no correct correspondences.

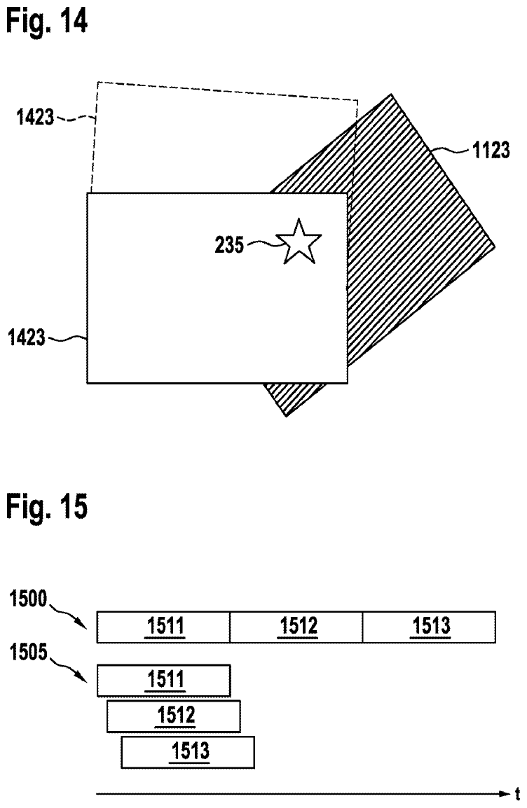

FIG. 13 shows a schematic representation of overlapping images 1123, 1323 and of image features 335 according to an exemplary embodiment. The image features 335 are extracted from image data representing the images 1123, 1323 by carrying out the method for determining localization data from FIG. 8 or a similar method. The positions of the image features 335 in images 1123, 1323 are thus determined by way of a random process and/or according to a predefined distribution scheme, in other words independently of a specific image content of images 1123, 1323.

In particular, the positions of the image features 335 in images 1123, 1323 are differently distributed.

The use of different patterns of feature positions or positions of the image features 335 in overlapping images 1123, 1323 can prevent the problem shown in FIG. 12 from occurring. In this case, there are overlapping feature image regions such that an association could be established for them during correspondence finding.

FIG. 14 shows a schematic representation of a reproducibility condition according to an exemplary embodiment. To this end, an image 1123 represented by image data, two reference images 1423 or mapping images represented by reference image data and a reference image feature 235 are shown. Images 1123 and 1423 overlap one another at least in part. The reproducibility condition states that, in the map generation method from FIG. 7 or a similar method in the determination step, the reference pose is determined as a function of correspondences between reference image features 235 for which reference feature descriptors satisfying a similarity criterion with regard to one another have been ascertained in overlapping reference images 1423.

In other words, the reference image feature 235 from a mapping image or reference image 1423 is only stored if the corresponding reference image feature 235 in an overlapping mapping image or reference image 1423 results in a similar feature descriptor. The probability of a corresponding image feature in a localization image or image 1123 likewise being evaluated to a similar feature descriptor can accordingly be increased.

FIG. 15 shows a schematic representation of a time sequence 1500, 1505 of three phases 1511, 1512, 1513 of centralized image feature-based localization. A time axis t is shown in the diagram for this purpose. A first sequence 1500 represents the three phases 1511, 1512, 1513 proceeding conventionally in a sequential or serial manner. A second sequence 1505 represents the three phases 1511, 1512, 1513 proceeding in parallel or at least partially parallel manner according to an exemplary embodiment. With reference to the method for determining localization data from FIG. 8 and the localization method from FIG. 9, the at least partially parallel second sequence 1505 is in particular enabled by carrying out the output step during the determination method. A first phase 1511 represents image processing, typically on the part of a mobile unit, a second phase 1512 represents communication or data transmission between mobile unit and server and a third phase 1513 represents localization, typically on the part of the server. In the second sequence 1505, the three phases 1511, 1512, 1513 can be carried out in overlapping manner, i.e. partially in parallel, resulting in a substantially shorter duration from start to finish of the localization process.

Exemplary embodiments and the background and advantages of exemplary embodiments are summarized once again in other words with reference to the above-described figures. According to exemplary embodiments, localization can be achieved on the basis of ground texture features.

One conventional approach to achieving this object involves determining corresponding features from an image captured for localization and one or more reference images. These correspondences can then be used to determine the pose consisting of the position and orientation of the camera or image acquisition apparatus at the time of capture of the localization image in relation to the reference images. The conventional approach can be subdivided, for example, into four phases:
1. Feature detection: Feature detection firstly involves determining a set of image regions (feature image regions) which are suitable for subsequent correspondence finding. These may, for example, be image regions which are particularly light or dark in comparison with their local surroundings or differ in some other manner from their local surroundings, or image regions with a specific structure (e.g. lines or corners). It is assumed here that these regions of ground texture also satisfy the selection criterion from another camera pose such that the same (or at least overlapping) feature image regions are found in a localization and reference image.
2. Feature description: Feature descriptors of these image regions are then computed in the feature description phase.
3. Correspondence finding: These descriptors are then used to determine corresponding features. It is here assumed that corresponding features have been described with similar descriptors, while the descriptors of non-corresponding features should have less similarity.
4. Pose determination: The proposed correspondences are finally used for pose determination, wherein it frequently makes sense to use a method which is robust to a proportion of incorrect correspondences.

An exemplary embodiment using random feature positions will firstly be described below, before possible extensions or other exemplary embodiments are discussed.

For map-based localization, the map 170 of the deployment area or deployment environment 100 is firstly prepared or created, as shown for example in FIG. 2 and FIG. 4 or FIG. 6 and FIG. 7. Map creation can be subdivided, for example, into five phases:
1. A vehicle or robot, possibly also a drone, as the mobile unit 120 traverses the entire deployment area or deployment environment 100 and, while doing so, captures in particular overlapping reference images 1423 of the ground 102.
2. A set of reference image features 235 is extracted for each captured reference image 1423. The positions of the reference image features 235 in the reference image 1423 are in particular determined using a random process. This random process could look like this: A list including all possible image positions, the image position list, is created, this list is then shuffled and the first n entries in the shuffled image position list are used to determine a set of image positions. Here, n represents the number of reference image features 235 to be extracted. As an alternative to shuffling the list, a random number generator could also be used n times to determine a random list index of the image position list and the respective entry in the list could be included as a further image feature position. In contrast to the first variant, the second variant involves less computational overhead but it may happen that the same image position is used repeatedly. To avoid this, each time a random list index is determined it could be checked whether the list index has already been used, which may somewhat increase computational overhead again. Which variant is most suitable depends on the application, in particular on the number of reference image features 235 to be extracted.
3. A feature descriptor is computed for each image feature position which has been determined in the previous phase. The procedure here depends on the selected feature description method. The size of the image portion under consideration may either be fixed by this feature description method or the user him/herself defines an appropriate size, or the size is determined by a suitable method on the basis of the image content of the region around the feature position. If the feature description method requires an orientation of the image portion under consideration, typically in order to rotate the image portion appropriately, this may either be determined using a suitable method on the basis of the region around the feature position, for example the direction with the steepest intensity gradients, or the current camera orientation is used such that all the features of a reference image 1423 are assigned the same orientation. The camera orientation may be either the relative orientation to the initial camera orientation from the first reference image 1423 captured for mapping, or an absolute orientation is used which is determined, for example, using a compass.
4. The reference poses 455 of the captured reference images 1423 are determined. The reference pose 455 of a first reference image 1423 can form the origin of the coordinate system, or a coordinate system with a known reference may be used, such as for example a coordinate system defined by a floor plan of the deployment environment 100. The image poses or reference poses 455 should be determined such that they are coherent with one another. The individual captures can to this end be combined to form a large image using a stitching process such that the reference images 1423 are then correctly positioned relative to one another.
5. The extracted reference image features 235 are efficiently stored. It makes sense to store the location in the coordinate system of the map 170 where the reference image features 235 are located. A map 170 which can be used for localization is thus created. The map 170 substantially comprises a set of reference images 1423 whose reference poses 455 have been optimized such that they can be placed correctly adjoining one another. In addition, a set of reference image features 235 at arbitrary or random positions has been extracted from each reference image 1423. The poses of the features in the world, i.e. relative to the coordinate origin of the map 170, are known; in addition a descriptor which can subsequently be used for correspondence formation during localization has been stored for each feature image region.

Subsequent map-based localization, as for example shown in FIG. 3 and FIG. 5 or FIG. 8 and FIG. 9, can be subdivided, for example, into six phases:
1. An image 1123, 1323 which is to be used for localization is captured in the mapped deployment environment 100.
2. Random or arbitrary image feature positions or positions of image features 335 are determined.
3. If the camera position is already approximately known, this information can be used to narrow down the search region for localization, for example by subsequently considering only those reference image features 235 in the vicinity of the estimated position.
4. In a similar manner as during map creation, feature descriptors are computed at the image feature positions. If an orientation is required for this purpose, it can either be redetermined in absolute terms, for example using a compass, or, if the camera orientation relative to the coordinate system of the map 170 is approximately known from a previous pose determination, this camera orientation can be used as a feature orientation.
5. A suitable method, such as for example nearest neighbor matching, is then used for correspondence finding in order to determine correspondences 555 between the mapped reference image features 235 and the image features 335 extracted from the localization image 1123, 1323.
6. The correspondences found in this way, some of which may be incorrect, are then used for pose estimation using a suitable method, such as for example a RANSAC-based estimation of a Euclidean transformation with subsequent Levenberg-Marquardt optimization.

According to one embodiment, what is known as incremental localization can also be carried out. The method from FIG. 8 can also be carried out in order to estimate or ascertain a relative camera pose with respect to a previous camera pose. This works in the same way as the previously described map-based localization, but with the difference that no mapped reference image features 235 from the map 170 are available for correspondence finding. Instead, incremental localization makes use of the reference image features 235 from the previous image 1123, 1323 or from a sequence of previous images 1123, 1323, together with the previously estimated pose thereof. One limitation of incremental localization in comparison with map-based localization is that inaccuracies can propagate from image to image such that the estimated pose can deviate increasingly significantly from the actual pose. Incremental localization can, however, in particular be used for regions of the deployment environment 100 which were not considered during mapping.

The presented concept of using random image feature positions or positions of reference image features 235 and image features 335 can be usefully extended. Using random or pseudorandom positions is in principle advantageous because the extracted reference image features 235 and image features 335 are on average uniformly distributed. The same also applies to the use of a fixed pattern of uniformly distributed positions, for example a grid or grid-like arrangement, but it may happen that the feature image regions of two overlapping reference images 1423 or images 1123, 1323 are shifted relative to one another precisely such that there are no correct feature correspondences between them (see also FIG. 12). Determining random positions can be more computationally intensive than using a fixed set of positions, for example uniformly distributed positions. It may therefore make sense to move away from the use of random feature positions. Depending on the application, there are possible alternatives:
1. For map-based localization: Random positions can be used for map creation since this process is typically not time-critical. Use can then be made of a predefined, fixed distribution of positions during localization, which is more time-critical.
2. For incremental localization: feature extraction in each image 1123, 1323 is time-critical here such that it can make sense to make exclusive use of fixed sets of feature positions.

Various patterns of feature positions can be used alternately to generally counteract the above-described limitation that the used feature positions of two overlapping reference images 1423 or images 1123, 1323 are shifted relative to one another precisely such that there are insufficient overlaps between the feature image regions (see also FIG. 13). Another approach to reducing computational overhead for example involves generating a relatively large number of random position patterns in advance such that they can be used sequentially during localization.

Depending on the application, it may make sense for reference image features 235 or image features 335 to be extracted at higher density for specific image regions than for other image regions:
1. With regard to map-based localization, the important factor here is the overlap of the reference images 1423 used for map creation. If they do not overlap or overlap only slightly, a uniform distribution of features achieves the greatest probability of finding correct correspondences 555 during localization, since it is not known at the time of determining the reference image features 235 how a later localization image 1123, 1323 will overlap with the mapping images or reference images 1423. When the reference images 1423 overlap, reference image features 235 are extracted for the overlap regions in a plurality of reference images 1423. In such a case, it might make sense to extract fewer features in the overlapping regions or at the edges of the reference images 1423 than in the non-overlapping regions or centers of the reference images 1423, such that an averaged uniform distribution of the features or their positions across all the reference images 1423 is obtained.
2. With regard to incremental localization, only those image regions which overlap with the previous or next images 1123, 1323 are of interest here. The overlap depends on the speed and direction of travel and the frequency of capture. It makes sense here to extract features only in the areas that can be assumed to overlap with a previous or upcoming image 1123, 1323, i.e. more features at the edges of the image.

A further useful extension is based on a concept which is also known as a reproducibility condition (see also FIG. 14). This is a condition which the reference image features 235 extracted during map creation must satisfy in order to be stored, wherein they are otherwise for example discarded and replaced by features which do satisfy the condition. The reproducibility condition requires that a feature image region or reference image feature 235 in two overlapping mapping images 1423 be evaluated to a similar feature descriptor and thus have a degree of robustness to image transformation, such as for example translation and rotation of the camera, and photometric transformations acting on the reference images 1423. It has been found that using this condition increases the probability that corresponding feature image regions between mapping images 1423 and localization images 1123, 1323 are likewise evaluated to similar feature descriptors such that the probability of finding correct correspondences 555 is increased.

According to a further exemplary embodiment, a fully parallelized localization system 110 in particular is proposed for example for robot swarms. This is an inexpensive solution for high-precision localization of mobile units 120, for example autonomous vehicles or robots. Two concepts are combined here:
(1) A centralized, server-based localization system 110, and (2) a localization method which is based on recognizing ground texture features in a previously created map 170.

A typical application for this and other exemplary embodiments is for example a warehouse in which a plurality or swarm of autonomous robots as mobile units 120 are responsible for transporting materials, goods, and tools. If the mobile units 120 are to be able to move autonomously, it is important for them to be aware of their pose, i.e. position and orientation. Depending on the task being performed by a mobile unit 120, differing levels of requirements for the precision and robustness of localization apply. For instance, it may be sufficient for a mobile unit 120 to be aware of its position with an accuracy of 10 cm while it is moving from one location to another, in particular providing it is capable of avoiding obstacles on an ad hoc basis. On the other hand, if the mobile unit 120 is, for example, to be automatically loaded with material at a particular location, positioning or localization with millimeter precision may be necessary. In an application in which a major part of goods transportation in the warehouse is to be undertaken by mobile units 120, a plurality of mobile units 120 acting simultaneously can be deployed. Suitable technology for localizing mobile units 120 in such a scenario is visual or feature-based localization with a downward-facing camera. This enables high-precision localization without the need for implementing infrastructure measures such as the installation of visual markers, reflectors or radio units. This type of localization also works under the more difficult conditions of dynamic surroundings, such as a warehouse, where there are no static landmarks for orientation, since shelving, for example, can be rearranged at any time. This is because ground textures typically remain stable in the long term, in particular in protected areas, such as a warehouse. Wear and tear which occurs over time typically occurs only in places, such that the affected areas on a map 170 of the application area or deployment environment 100 can furthermore be detected on the basis of their surroundings and then appropriately updated.

Ground texture-based localization is in particular based on the fact that visual features of the ground 102 can be used in the manner of a fingerprint to uniquely identify a location on the ground 102. Typically, it is not a single feature, such as for example asphalt, which is unambiguously recognizable but instead a constellation of a plurality of such visual ground texture features. Before the actual localization can be carried out, the deployment environment 100 is mapped, i.e. reference images 1423 are captured during one or more mapping runs, and their relative pose to one another is determined in an optimization method, for example by way of image stitching, such that the reference images 1423 can then be placed correctly adjoining one another. Using a map 170 created in this manner, a mobile unit 120 can then be localized by again finding mapped reference image features 235 in the image 1123, 1323 captured for localization.

When it comes to inexpensively implementing ground texture-based localization for a plurality of mobile units 120 in the form of a robot swarm or the like, it may make sense for some of the computational overhead to be outsourced by the mobile units 120 and carried out on a central server or a data processing apparatus 140. In one simple variant, the images 1123, 1323 of the ground 102 captured for localization could be sent to the server unprocessed such that image processing and subsequent feature-based localization would be completely outsourced. This variant may, however, be unfavorable because in such a constellation the mobile units 120 can no longer act independently, but would have to rely on a stable and fast connection to the server. In addition, images have a large memory footprint and would result in a correspondingly large communication overhead. A more sensible variant is therefore to carry out image processing on the mobile unit 120 and only transmit extracted image features 335 to the server for localization. The communication overhead is much lower in this variant and the mobile unit 120 can optionally act independently of the server, at least temporarily, by determining its current pose each time relative to the previous one. The advantage over a variant which is carried out in fully decentralized manner, i.e. on the respective mobile units 120, is that the map 170 is stored not on the mobile units 120, but instead just on the server and that the greater overhead involved in absolute localization in comparison with relative localization is outsourced. Absolute localization means here that the pose of the mobile unit 120 is determined on the basis of a previously captured and optimized map 170.

At least one exemplary embodiment proposes an efficient implementation of centralized ground texture feature-based localization in which image processing and relative pose determination (visual odometry) take place on the mobile units 120 while absolute pose determination on the basis of a previously captured map 170 is outsourced to a central server or the data processing device 140. The three phases of localization, i.e. image processing 1511, communication 1512 and localization 1513, are here carried out in parallel or in partially temporally overlapping manner. This is enabled by making use of arbitrary or pseudorandom feature image regions or positions thereof or in other words global optimality is dispensed with. The use of arbitrarily arranged feature image regions differs from conventional methods in which the optimal feature image regions which are best suited for correspondence finding with the reference features are determined globally or in the entire image. In such conventional methods, however, the entire image must be considered in its entirety if the criterion of global optimality is to be satisfied. The entire image thus has to be fully processed before a set of suitable features is found and can be forwarded to the server. According to exemplary embodiments, however, it is possible to dispense with global optimality of the extracted features in ground texture-based localization because for example the degrees of freedom of the robot's pose can be reduced to two (x and y positions), since the distance to the ground is known with high accuracy and orientation can be estimated to a good approximation, either absolutely with a compass or relatively in relation to the previous pose, and because it is sufficient to use random feature image regions since ground textures have a very high information density, such that arbitrary image regions can be used for unique fingerprint-like identification of the ground area. Using random or arbitrary positions in particular for the image features 335 means that one feature can be computed after the other and then sent directly to the server or to the data processing apparatus 140. The server thus receives a constant stream of extracted image features 335 from the at least one mobile unit 120 such that image processing 1511 and communication 1512 can be carried out in parallel or in temporally partially overlapping manner. The subsequent localization 1513 which takes place on the server on the basis of the received image features 335 from the localization image 1123, 1323 and the map 170 of the application area or deployment environment 100 can likewise be carried out in parallel or in temporally partially overlapping manner. A voting method or procedure in which each found feature correspondence or correspondence 555 casts a vote for the position of the camera at the time of capture can be used for this purpose. Such a method allows correspondences 555 to be entered sequentially in parallel or in temporally partially overlapping manner for communication 1512 and image processing 1511.

In a conventional concept of a centralized localization system, in which corresponding image features are used for localization and in which some of the necessary computations are outsourced to a server (see e.g. Schmuck and Chli (2019); Kim et al. (2019)), localization is considered to proceed as a sequential process, i.e. image processing 1511 takes place first, once this is complete the information required for localization 1513 is completely transferred to the server and, once communication 1512 with the server is complete, the server computes a pose estimate for the robot, as shown as the first sequence 1500 in FIG. 15.

According to exemplary embodiments, a conventional concept of the centralized localization system can be improved by the localization taking place not in sequential phases, but in parallel, i.e. in temporally partially overlapping processes or phases, such that localization can be completed significantly faster, see also the second sequence 1505 in FIG. 15. This is made possible inter alia by using ground texture images instead of images from forward-facing cameras, as well as by dispensing with globally or image-wide optimal image features. It has been found that arbitrary image feature regions can be used in ground texture-based localization. This would not be the case for images from forward-facing cameras because this is a more complex problem where the size of the image feature regions used is critical to finding correct correspondences between map and localization image, and additionally relatively large parts of the observed environment would not be suitable for correspondence formation, e.g. because they are not static or contain little visual information. For downward-facing cameras, it is possible to use a constant size of the used image feature regions since the distance to the ground 102 is substantially constant. It has additionally been found that typical ground textures everywhere have sufficient information content for correspondence formation.

According to exemplary embodiments, centralized image-based localization can be accelerated. This overcomes the shortcoming in conventional localization methods that a long period of time can elapse between capture of the localization image and completion of pose estimation. This is of particular relevance when elevated positioning accuracy is required because even if the pose of the localization image is determined very accurately, the mobile unit will have moved on in the meantime such that the current pose would have to be determined more inaccurately by estimating the distance traveled in the meantime. If a unit is so dependent on a high-precision pose estimate that it would have to remain stationary until it received the pose estimate from the server, it would likewise benefit from exemplary embodiments because stationary times could be reduced.

The advantage of a localization method implemented according to exemplary embodiments which makes use of image-based methods for localization is that it is an infrastructure-free solution, i.e. the deployment environment 100 need not (necessarily) be adapted for it, but instead existing landmarks are used for determining location. In addition, cameras are inexpensive, e.g. in comparison with radar, function indoors and outdoors, which is not the case e.g. for GPS, and permit high-precision pose determination, e.g. in comparison with radiometry. The advantage of an image-based localization method implemented according to exemplary embodiments which use a downward-facing camera to capture ground texture images is that it also works in a deployment environment 100 in which objects can be relocated at any time, or where visibility of the environment may be limited, e.g. in warehouses or among crowds of people. In addition, high-precision localization is easy to implement according to exemplary embodiments because, in comparison with the features from images from forward-facing cameras, the observed visual features are very close to the camera and, when dedicated artificial lighting is used, for example by way of the at least one lighting apparatus 124, localization functions independently of external light conditions.

The advantage of a ground texture-based localization method implemented according to exemplary embodiments which use arbitrary or random feature image regions or positions thereof for correspondence formation is that the computational overhead of image processing can be reduced since, in contrast to the use of a (typical) feature detector, it is not necessary to process the entire image completely in order to identify, for example, optimal feature image regions. Instead, according to exemplary embodiments, features are ascertained at arbitrary locations of the reference image 1423 or the image 1123, 1323. Such a method additionally has the advantage that it is not necessary for image processing to be complete before the information can be used in the next processing step. Image processing can instead be carried out incrementally, i.e. feature by feature, while the previously obtained information is already available in the next processing step. The advantage of a localization method implemented according to exemplary embodiments which partially outsources memory and computational overhead to a central server is that these capacities can be saved on the individual mobile units 120, such as for example autonomous vehicles, robots or the like, such that inexpensive scaling of swarm size is achieved.

Exemplary embodiments in particular present a centralized ground texture-based localization method in which arbitrary image regions are used for feature extraction. One advantage this has over a conventional centralized localization method is that localization can be carried out more quickly such that higher positioning accuracy can be achieved.

A simple exemplary embodiment will now firstly be described before some possible alternatives and extensions are discussed. As shown in FIG. 1, the methods 600, 700, 800, 900 from FIGS. 6 to 9 are deployed using a system 110 which includes one or more mobile units 120, for example robots or other vehicles to be localized, and a central server or a data processing apparatus 140. Each mobile unit is in particular equipped with a downward-facing camera or image acquisition apparatus 122, and a computing unit and a radio module, for example WLAN or mobile radio. The capture region of the camera can optionally be illuminated by artificial lighting such that capture is, on the one hand, independent of external light conditions and short exposure times of the camera can be achieved so that the images have as little motion blur as possible. The server itself has computing capabilities, a radio module for communication with the mobile units 120, and a memory which in particular contains the entire prerecorded map 170 of the deployment environment 100. The localization method can in principle be subdivided into two parts, creation of the map 170 and the actual localization.

The deployment environment 100 can be mapped using a mobile unit 120 specifically designed for this purpose which can for example capture a wide swath of the ground 102 at once, or at least some of the normal mobile units 120 or application robots can be used. The deployment environment 100 is for example traversed and thus scanned in its entirety. A long sequence of overlapping ground texture images or reference images 1423 is then available, from which the reference image features 235 are extracted. Each reference image feature 235 is on the one hand defined by its associated image region, for example by the image coordinates of its center point and a radius and an angle of orientation, and on the other hand a feature descriptor which describes the associated feature image region is computed for each reference image feature 235. A suitable feature detection method is typically used to find the best feature image regions in the reference image 1423. A feature image region is here well suited if there is a high level of probability that a similar image region can also be found in overlapping reference images 1423. Conventionally, it is those image regions in which a specific property is most strongly manifested (global optimization) which are determined. One example of such a property would be contrast relative to the local surroundings. Exemplary embodiments, however, make use of a method without global optimization because it has been found that it is sufficient to use random or arbitrary positions for ground texture-based localization. Other smart methods may, however, also be used providing they do not require global optimization. For example, the reference image 1423 can be systematically searched for locations with a specific property, for example locations which look like corners, edges, or intersections. Common methods, such as SIFT (Lowe (2004)), or a faster method, such as BRIEF (Calonder et al. (2010)) can then be used for feature description. After feature extraction, correspondences between the features of overlapping reference images 1423 are found. For this purpose, a distance measure between feature descriptors is typically computed such that features with similar descriptors can be proposed as corresponding. Incorrect correspondences can then be filtered out and, on the basis of the remaining correspondences, the poses of the reference images 1423 are estimated such that their overlaps are correctly superimposed and a kind of mosaic of the captured ground 102 can be obtained. The optimized image poses, together with the extracted reference image features, are stored in the map 170 on the server such that the pose of a localization image 1123, 1323 within the map 170 can be determined during the actual localization.

For localization, a mobile unit 120 which wishes to localize itself captures an image 1123, 1323 of the ground 102. One image feature 335 after the other is then extracted and the following sequence is initiated for each image feature 335:
1. Image processing on the robot: A feature image region is determined, which should be carried out using the same method as during mapping, for example by a random process.
2. Image processing on the robot: A feature descriptor for the feature image region is computed using the same method as during mapping for feature description.
3. Communication: The localization data 180, i.e. information about the selected feature image region, in particular the image coordinates and the descriptor, are sent to the server.
4. Localization on the server: The localization data 180 reach the server, where the map 170 is searched for corresponding image features. If the approximate pose of the mobile unit 120 is already known, the search region can be narrowed down.
5. Localization on the server: The correspondences 555 so far found during the localization process are used to determine the pose of the mobile unit 120. For example, a voting method can be used in which each correspondence 555 casts one vote for the correct pose on the map 170, wherein the quantity of votes is expanded with each processed image feature 335. As soon as sufficient image features 335 have been processed, or as soon as confidence in the current pose estimate is high enough, the server can inform the mobile unit 120 of its pose such that image processing and communication can be terminated.

According to one exemplary embodiment, in order to maintain sufficiently high positioning accuracy, the pose of a moving mobile unit 120 can be updated at short intervals. Update rates of 10 to 60 hertz would be possible. However, in a system 110 with a plurality of mobile units 120, this could result in a huge communication overhead, such that it may make sense to have only every n^{th} update carried out on the server. For the intermediate steps, the pose could in each case be computed relative to the previous one (visual odometry). Map-based absolute localization via the server could then be used only to regularly correct the accumulated error (drift) of the local pose estimate on the mobile unit 120.

According to one exemplary embodiment, a confidence value for the current pose estimate is determined on the server or data processing unit 140 such that localization can be completed as soon as this value has exceeded a defined threshold.

Instead of a downward-facing camera, an upward-facing camera could possibly also be used in a similar manner. However, this only functions indoors and with a known ceiling height. In this case, instead of the floor 102, a ceiling of the deployment environment 100 is captured.

In the system 110 described here, it has for example been assumed that there is a stand-alone mapping run. It is likewise possible for the map 170 to be created online by the mobile units 120. To this end, the mobile units 120 could each create local maps of their own which at a later time would be combined on the server to form the map 170 as one large common map. This would then be a system for simultaneous localization and mapping (SLAM).

Instead of always transmitting one extracted image feature 335 after the other, it may make sense from a communication standpoint to transmit a set of features all at once to reduce the communication overhead.

In a possible variant without a server, in which computation proceeds entirely on the mobile unit 120, it may also be advantageous to parallelize both image processing and localization. This may be used to improve utilization of the available hardware, for example with multicore processors or if some of the computation can be outsourced to dedicated hardware such as graphics cards. In addition, image processing can be terminated here too as soon as confidence in the current pose estimate is sufficiently high.

1-15. (canceled)

16. A method for providing mapping data for a map of a deployment environment for at least one mobile unit, the method comprising the following steps:
reading in reference image data from an interface to an image acquisition apparatus of the mobile unit, wherein the reference image data represent a plurality of reference images captured using the image acquisition apparatus from subportions specific to each reference image of the ground of the deployment environment, wherein adjacent subportions partially overlap;
extracting a plurality of reference image features from each of the reference images using the reference image data, wherein positions of the reference image features in each of the reference images are determined using a random process and/or according to a predefined distribution scheme; and
producing the mapping data, wherein, using the reference image data, a reference feature descriptor is ascertained at the position of each of the reference image features, and wherein the mapping data include the reference image data, the positions of the reference image features, and the reference feature descriptors.

17. A method for creating a map of a deployment environment for at least one mobile unit, the method comprising the following steps:
receiving mapping data from a communication interface to the at least one mobile unit, the mapping data being produced by:
reading in reference image data from an interface to an image acquisition apparatus of the mobile unit, wherein the reference image data represent a plurality of reference images captured using the image acquisition apparatus from subportions specific to each reference image of the ground of the deployment environment, wherein adjacent subportions partially overlap,
extracting a plurality of reference image features from each of the reference images using the reference image data, wherein positions of the reference image features in each of the reference images are determined using a random process and/or according to a predefined distribution scheme, and
producing the mapping data, wherein, using the reference image data, a reference feature descriptor is ascertained at the position of each of the reference image features, and wherein the mapping data include the reference image data, the positions of the reference image features, and the reference feature descriptors;
determining a reference pose of the image acquisition apparatus for each of the reference images relative to a reference coordinate system using the mapping data and as a function of correspondences between the reference image features of overlapping ones of reference images ascertained using the reference feature descriptors; and
combining the reference images as a function of the reference poses, the positions of the reference image features, the reference feature descriptors, and the reference poses, to create the map of the deployment environment.

18. The method as recited in claim 17, wherein, in the determining step, each of the reference poses is determined as a function of correspondences between reference image features for which reference feature descriptors satisfying a similarity criterion with regard to one another have been ascertained in the overlapping reference images.

19. A method for determining localization data for localizing at least one mobile unit in a deployment environment, the method comprising the following steps:
reading in image data from an interface to an image acquisition apparatus of the mobile unit, wherein the image data represent at least one image, which is captured using the image acquisition apparatus, of a subportion of a ground of the deployment environment;
extracting a plurality of image features for the image using the image data, wherein positions of the image features in the image are determined using a random process and/or according to a predefined distribution scheme;
generating a feature descriptor at the position of each of the image features using the image data to determine the localization data, wherein the localization data include the positions of the image features and the feature descriptors.

20. The method as recited in claim 19, further comprising:
outputting the localization data at an interface to a data processing apparatus, wherein the localization data are output in a plurality of data packets, wherein each of the data packets includes at least one position of an image feature and at least one feature descriptor, wherein a data packet is output at soon as at least one feature descriptor is generated.

21. The method as recited in claim 19, further comprising:
eliciting correspondences between image features of the localization data and reference image features of a preceding image using the feature descriptors of the localization data and reference feature descriptors of the preceding image; and
determining a pose of the image acquisition apparatus for the image relative to a reference coordinate system as a function of the correspondences elicited in the step of eliciting correspondences, in order to carry out localization.

22. The method as recited in claim 16, in which a random process and/or a predefined distribution scheme is used in the extracting step: (i) in which a list with all possible image positions of reference image features is produced and the list is pseudorandomly shuffled or positions are pseudorandomly selected from the list, and/or (ii) in which a fixed pattern of positions or one of a number of pseudorandomly created patterns of positions is used.

23. The method as recited in claim 16, wherein in which a random process and/or a predefined distribution scheme is used in the extracting step, in which a variable or defined number of positions is used and/or in which different distribution densities of positions are defined for different subregions of each reference image.

24. A method for localizing at least one mobile unit in a deployment environment, the method comprising the following steps:
receiving localization data from a communication interface to the at least one mobile unit, wherein the localization data are determined by:
reading in image data from an interface to an image acquisition apparatus of the mobile unit, wherein the image data represent at least one image, which is captured using the image acquisition apparatus, of a subportion of a ground of the deployment environment,
extracting a plurality of image features for the image using the image data, wherein positions of the image features in the image are determined using a random process and/or according to a predefined distribution scheme,
generating a feature descriptor at the position of each of the image features using the image data to determine the localization data, wherein the localization data include the positions of the image features and the feature descriptors;
ascertaining correspondences between the image features of the localization data and reference image features of a map using the feature descriptors of the localization data and reference feature descriptors of the map, the map being generated by:
receiving mapping data from a communication interface to the at least one mobile unit, the mapping data being produced by:
reading in reference image data from an interface to an image acquisition apparatus of the mobile unit, wherein the reference image data represent a plurality of reference images captured using the image acquisition apparatus from subportions specific to each reference image of the ground of the deployment environment, wherein adjacent subportions partially overlap,
extracting a plurality of reference image features from each of the reference images using the reference image data, wherein positions of the reference image features in each of the reference images are determined using a random process and/or according to a predefined distribution scheme, and
producing the mapping data, wherein, using the reference image data, a reference feature descriptor is ascertained at the position of each of the reference image features, and wherein the mapping data include the reference image data, the positions of the reference image features, and the reference feature descriptors;
determining a reference pose of the image acquisition apparatus for each of the reference images relative to a reference coordinate system using the mapping data and as a function of correspondences between the reference image features of overlapping ones of reference images ascertained using the reference feature descriptors; and
combining the reference images as a function of the reference poses, the positions of the reference image features, the reference feature descriptors, and the reference poses, to create the map of the deployment environment;
determining a pose of the image acquisition apparatus for the image relative to the reference coordinate system as a function of the correspondences ascertained in the ascertaining step and using the reference poses of the map to generate pose information which represents the pose; and
outputting the pose information at the communication interface to the at least one mobile unit, to carry out localization.

25. The method as recited in claim 24, wherein, in the determining step, weighting values and/or confidence values are applied to the correspondences ascertained in the ascertaining step to generate scored correspondences, wherein the pose is determined as a function of the scored correspondences.

26. A device for a mobile unit, wherein the device is configured to provide mapping data for a map of a deployment environment for at least one mobile unit, the device configured to:
read in reference image data from an interface to an image acquisition apparatus of the mobile unit, wherein the reference image data represent a plurality of reference images captured using the image acquisition apparatus from subportions specific to each reference image of the ground of the deployment environment, wherein adjacent subportions partially overlap;
extract a plurality of reference image features from each of the reference images using the reference image data, wherein positions of the reference image features in each of the reference images are determined using a random process and/or according to a predefined distribution scheme; and
produce the mapping data, wherein, using the reference image data, a reference feature descriptor is ascertained at the position of each of the reference image features, and wherein the mapping data include the reference image data, the positions of the reference image features, and the reference feature descriptors.

27. A device for a data processing apparatus, the device configured to create a map of a deployment environment for at least one mobile unit, the device configured to:
receive mapping data from a communication interface to the at least one mobile unit, the mapping data being produced by:
reading in reference image data from an interface to an image acquisition apparatus of the mobile unit, wherein the reference image data represent a plurality of reference images captured using the image acquisition apparatus from subportions specific to each reference image of the ground of the deployment environment, wherein adjacent subportions partially overlap,
extracting a plurality of reference image features from each of the reference images using the reference image data, wherein positions of the reference image features in each of the reference images are determined using a random process and/or according to a predefined distribution scheme, and
producing the mapping data, wherein, using the reference image data, a reference feature descriptor is ascertained at the position of each of the reference image features, and wherein the mapping data include the reference image data, the positions of the reference image features, and the reference feature descriptors;
determine a reference pose of the image acquisition apparatus for each of the reference images relative to a reference coordinate system using the mapping data and as a function of correspondences between the reference image features of overlapping ones of reference images ascertained using the reference feature descriptors; and
combine the reference images as a function of the reference poses, the positions of the reference image features, the reference feature descriptors, and the reference poses, to create the map of the deployment environment.

28. A localization system for a deployment environment in which at least one mobile unit is deployable, wherein the localization system comprises:
the at least one mobile, wherein the mobile unit has a device configured to provide mapping data for a map of a deployment environment for at least one mobile unit, the device configured to:
read in reference image data from an interface to an image acquisition apparatus of the mobile unit, wherein the reference image data represent a plurality of reference images captured using the image acquisition apparatus from subportions specific to each reference image of the ground of the deployment environment, wherein adjacent subportions partially overlap;
extract a plurality of reference image features from each of the reference images using the reference image data, wherein positions of the reference image features in each of the reference images are determined using a random process and/or according to a predefined distribution scheme; and
produce the mapping data, wherein, using the reference image data, a reference feature descriptor is ascertained at the position of each of the reference image features, and wherein the mapping data include the reference image data, the positions of the reference image features, and the reference feature descriptors; and
a data processing apparatus, wherein the data processing apparatus is configured to create a map of a deployment environment for at least one mobile unit, the data processing device configured to:
receive the mapping data from a communication interface to the at least one mobile unit,
determine a reference pose of the image acquisition apparatus for each of the reference images relative to a reference coordinate system using the mapping data and as a function of correspondences between the reference image features of overlapping ones of reference images ascertained using the reference feature descriptors, and
combine the reference images as a function of the reference poses, the positions of the reference image features, the reference feature descriptors, and the reference poses, to create the map of the deployment environment;
wherein the device for the mobile unit and the data processing apparatus are connected to one another in data transmission enabled manner.

29. A non-transitory machine-readable storage medium on which is stored a computer program for providing mapping data for a map of a deployment environment for at least one mobile unit, the computer program, when executed by a computer, causing the computer to perform the following steps:
reading in reference image data from an interface to an image acquisition apparatus of the mobile unit, wherein the reference image data represent a plurality of reference images captured using the image acquisition apparatus from subportions specific to each reference image of the ground of the deployment environment, wherein adjacent subportions partially overlap;
extracting a plurality of reference image features from each of the reference images using the reference image data, wherein positions of the reference image features in each of the reference images are determined using a random process and/or according to a predefined distribution scheme; and
producing the mapping data, wherein, using the reference image data, a reference feature descriptor is ascertained at the position of each of the reference image features, and wherein the mapping data include the reference image data, the positions of the reference image features, and the reference feature descriptors.
